(19) United States
(12) Patent Application Publication
(10) Pub. No.: US 2025/0382422 A1
(43) Pub. Date: Dec. 18, 2025

(54) SILICONE RUBBER INSULATOR SHED MATERIAL, AND SILICONE RUBBER INSULATOR AND PREPARATION METHOD THEREFOR AND APPLICATION THEREOF

(71) Applicant: ELECTRIC POWER RESEARCH INSTITUTE, CHINA SOUTHERN POWER GRID, Guangzhou, Guangdong (CN)

(72) Inventors: Xiangjun ZENG, Guangzhou, Guangdong (CN); Haofeng ZHANG, Guangzhou, Guangdong (CN); Wei XIAO, Guangzhou, Guangdong (CN); Yongsheng XU, Guangzhou, Guangdong (CN); Bing LUO, Guangzhou, Guangdong (CN); Tingting WANG, Guangzhou, Guangdong (CN); Shaojie CHEN, Guangzhou, Guangdong (CN); Gangyi XU, Guangzhou, Guangdong (CN); Ruiqi SHANG, Guangzhou, Guangdong (CN)

(73) Assignee: ELECTRIC POWER RESEARCH INSTITUTE, CHINA SOUTHERN POWER GRID, Guangzhou, Guangdong (CN)

(21) Appl. No.: 18/878,741

(22) PCT Filed: Dec. 8, 2022
(86) PCT No.: PCT/CN2022/137484

§ 371 Date: Dec. 24, 2024

(30) Foreign Application Priority Data
Oct. 28, 2022 (CN) 202211336047.6

(51) Int. Cl. C08G 77/20; B29C 70/68; B29K 83/00; B29K 105/24; B29L 31/34; C08G 77/06; C08G 77/16; C08J 3/20; C08J 3/24; C08K 3/04; C08K 3/22; C08K 3/34; C08K 5/14; C08K 13/02; H01B 3/28

(52) U.S. Cl. CPC C08G 77/20; C08G 77/06; C08G 77/16; C08J 3/203; C08J 3/244; C08J 3/247; C08K 13/02; H01B 3/28; B29C 70/68; B29K 2083/00; B29K 2105/24; B29K 2995/0007; B29L 2031/3412; C08J 2383/04; C08K 3/04; C08K 2003/2227; C08K 2003/2272; C08K 3/346; C08K 5/14

(57) ABSTRACT

A silicone rubber insulator shed material, and a silicone rubber insulator and a preparation method therefor and an application thereof. The components of the silicone rubber insulator shed material comprise silicone rubber, iron oxide, nano-montmorillonite, fumed silica, aluminum hydroxide, a silane coupling agent, a vulcanizing agent, and hydroxy silicone oil, wherein the iron oxide and the nano-montmorillonite can slow down the thermal oxidation decomposition of the silicone rubber, thus improving the hydrophobicity, hydrophobic mobility and hydrophobic recovery of the silicone rubber composite insulator, thereby solving the technical problem in the prior art that the aging decomposition resistance of silicone rubber needs to be improved.

### CROSS REFERENCE OF RELATED APPLICATION

This application claims priority to Chinese Patent Application No. 202211336047.6, titled “SILICONE RUBBER INSULATOR SHED MATERIAL, AND SILICONE RUBBER INSULATOR AND PREPARATION METHOD THEREFOR AND APPLICATION THEREOF”, filed on Oct. 28, 2022 with the China National Intellectual Property Administration, which is incorporated herein by reference in its entirety.

### FIELD

The present disclosure relates to the field of insulator technology, and in particular to a silicone rubber insulator shed material, a silicone rubber insulator, preparation method therefor, and application thereof.

### BACKGROUND

Silicone rubber composite insulators have become the key equipment for preventing pollution flashover and suppressing surface discharge in Chinese's power system due to their excellent anti-pollution flashover performance. The silicone rubber composite insulators play an important role in the external insulation equipment of power transmission lines.

However, the silicone rubber composite insulators are operated outdoors for a long time, and sheds are directly exposed to the harsh environment. With the extension of the operating time, the sheds of the silicone rubber composite insulators are particularly prominent in aging and decomposition, which have an impact on mechanical properties and insulation properties of the silicone rubber composite insulators. In addition to causing a certain decrease in the mechanical properties of the sheds of the silicone rubber composite insulators, such as the elongation at break, it also has an adverse effect on the hydrophobicity, hydrophobic migration and hydrophobic recovery of the silicone rubber composite insulators. Conventional amount of alumina added to silicone rubber composite insulators will destroy the stable structure of the silicone rubber matrix and easily lead to the aging and decomposition of silicone rubber, thereby causing a decrease in the hydrophobicity, hydrophobic migration and hydrophobic recovery of the silicone rubber composite insulator, and a decrease in the pollution flashover and wet flashover performances of the insulator. Therefore, it is necessary to improve the aging and decomposition resistance of silicone rubber composite insulators.

### SUMMARY

In view of the above, a silicone rubber insulator shed material, a silicone rubber insulator, preparation method therefor and application thereof are provided according to embodiments of the present disclosure, in order to solve the technical problem that the aging and decomposition resistance of silicone rubber in the conventional technology needs to be improved.

In a first aspect, a silicone rubber insulator shed material is provided according to an embodiment of the present disclosure. The silicone rubber insulator shed material comprises components of silicone rubber, iron oxide, nano-montmorillonite, white carbon black, aluminum hydroxide, silane coupling agent, vulcanizing agent and hydroxy silicone oil.

Preferably, the silicone rubber insulator shed material comprises 100 parts by weight of the silicone rubber, 4 to 8 parts by weight of the iron oxide, 3 to 7 parts by weight of the nano-montmorillonite, 25 to 40 parts by weight of the white carbon black, 70 to 90 parts by weight of the aluminum hydroxide, 2 to 4 parts by weight of the silane coupling agent, 1 to 3 parts by weight of the vulcanizing agent, and 3 to 5 parts by weight of the hydroxy silicone oil.

Preferably, the silicone rubber includes methyl vinyl silicone rubber.

Preferably, the nano-montmorillonite includes organic hydrophobic modified nano-montmorillonite.

Preferably, the white carbon black includes fumed white carbon black.

Preferably, the silane coupling agent includes a vinyl silane coupling agent.

Preferably, the vulcanizing agent includes 2,5-dimethyl-2,5-bis(tert-butylperoxy) hexane.

Preferably, the methyl vinyl silicone rubber includes a methyl vinyl silicone rubber with a vinyl content of 0.16% and another methyl vinyl silicone rubber with a vinyl content of 3%. The mass ratio of the methyl vinyl silicone rubber with the vinyl content of 0.16% to the methyl vinyl silicone rubber with the vinyl content of 3% is 80 to 90:10 to 20.

In a second aspect, a method for preparing a silicone rubber insulator shed material is provided according to an embodiment of the present disclosure. The method comprises following steps:
Step S1, mixing dried fumed white carbon black, aluminum hydroxide and silicone rubber to obtain a silicone rubber insulator material to be cross-linked;
Step S2, cross-linking the silicone rubber insulator material to be cross-linked, iron oxide, organic hydrophobic modified nano-montmorillonite, silane coupling agent and hydroxy silicone oil to obtain a silicone rubber insulator material to be vulcanized;
Step S3, vulcanizing the silicone rubber insulator shed material to be vulcanized with the vulcanizing agent to obtain a silicone rubber insulator shed material.

Preferably, in step S1, the mixing is carried out in a kneader, for a kneading time of 0.5 to 1 h.

Preferably, mixing the dried fumed white carbon black, aluminum hydroxide and silicone rubber comprises:
Step S1.1, mixing a first batch of fumed white carbon black, aluminum hydroxide and silicone rubber to obtain a first batch of silicone rubber insulator shed material to be cross-linked;
Step S1.2, mixing remaining fumed white carbon black and aluminum hydroxide with the first batch of silicone rubber insulator shed material to be cross-linked in batches to obtain the silicone rubber insulator shed material to be cross-linked.

Preferably, in step S2, the cross-linking is performed at a reaction temperature of 130 to 160° C. for a reaction time of 2 to 3 h.

Preferably, the cross-linking reaction is carried out in a kneader by vacuum meshing cross-linking with a vacuum degree of 0.05 to 0.25 MPa.

Preferably, in step S3, the vulcanizing is performed at a reaction temperature of 165 to 185° C. and a pressure of 10 to 12 MPa for a reaction time of 10 to 14 min.

In a third aspect, a method for preparing a silicone rubber insulator shed is provided according to an embodiment of the present disclosure. The method comprises: step S4, placing the silicone rubber insulator shed material and an insulator core rod into a vulcanizer mold for molding to obtain a silicone rubber insulator shed.

Preferably, the molding is performed at a reaction temperature of 170 to 190° C. and a pressure of 15 MPa for a reaction time of 15 to 20 min.

Preferably, the insulator core rod is an insulator core rod coated with a binder and pre-baked.

In a fourth aspect, a silicone rubber insulator shed is provided according to an embodiment of the present disclosure, which is prepared by a method for preparing a silicone rubber insulator shed.

In a fifth aspect, an application of a silicone rubber insulator shed in ultra-high voltage, extra-high voltage, and high voltage insulators is provided according to an embodiment of the present disclosure.

In summary, a silicone rubber insulator shed material, a silicone rubber insulator, and preparation method therefor and application thereof are provided according to embodiments of the present disclosure. The silicone rubber insulator shed material comprises components of silicone rubber, iron oxide, nano-montmorillonite, fumed white carbon black, aluminum hydroxide, a silane coupling agent, a vulcanizing agent, and hydroxy silicone oil. The iron oxide can react with the silicon dioxide decomposed from the silicone rubber to generate mullite. The mullite effectively isolates heat and oxygen and slows down the thermal oxygen decomposition of the silicone rubber. The silicone rubber insulator has excellent hydrophobicity, hydrophobic migration, and hydrophobic recovery, so that wet flashover rarely occurs on the silicone rubber insulator. Under the local high temperature caused by dry strip arc, the silicate component of the nano-montmorillonite can form a ceramic layer on the surface of the silicone rubber, which can effectively isolate heat and oxygen and slow down the thermal oxygen decomposition of the silicone rubber. Meanwhile, a layered structure of the nano-montmorillonite can also effectively block the transfer of heat to the inside, and slow down the thermal oxygen decomposition of the silicone rubber, thereby solving the technical problem in the conventional technology that the aging and decomposition resistance performance of the silicone rubber needs to be improved.

### BRIEF DESCRIPTION OF THE DRAWINGS

FIG. 1 is a graph showing leakage resistance test results of silicone rubber insulator shed material according to Examples 2-5 and Comparative Example 1 of the present disclosure.

FIG. 2 is a graph showing carbon element analysis results of silicone rubber insulator shed material surface according to Comparative Example 1 of the present disclosure.

FIG. 3 is a graph showing carbon element analysis results of silicone rubber insulator shed material surface according to Example 5 of the present disclosure.

FIG. 4 is a graph showing XRD results of the silicone rubber insulator shed material according to Comparative Example 1 of the present disclosure.

FIG. 5 is a graph showing the XRD results of the silicone rubber insulator shed material according to Example 5 of the present disclosure.

FIG. 6 is a black and white comparison image of the color image shown in FIG. 2 of the present disclosure.

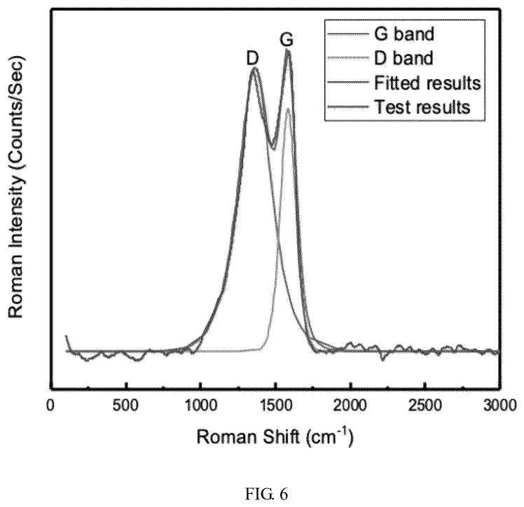

FIG. 7 is a black and white comparison image of the color image shown in FIG. 3 of the present disclosure.

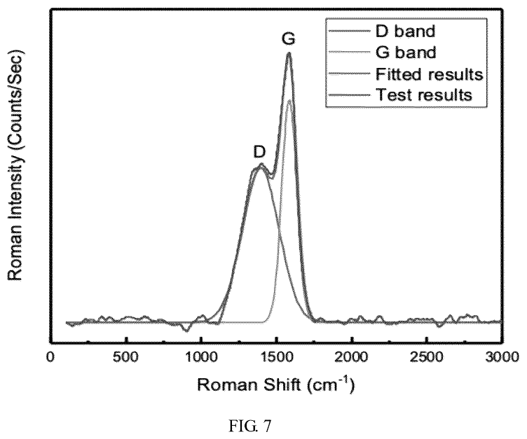

### DETAILED DESCRIPTION

A silicone rubber insulator shed material, a silicone rubber insulator, and preparation method therefor and application thereof are provided according to embodiments of the present disclosure, in order to solve the technical problem in the conventional technology that the aging and decomposition resistance of silicone rubber needs to be improved.

The technical solution of the present disclosure will be described clearly and completely in conjunction with the accompanying drawings. Apparently, the described examples are some, not all of the examples of the present disclosure. Based on the examples in the present disclosure, all other examples obtained by those skilled in the art without creative work are within the scope of protection of the present disclosure.

### Example 1

In example 1, a silicone rubber insulator shed material comprising components of silicone rubber, iron oxide, nano-montmorillonite, fumed white carbon black, aluminum hydroxide, silane coupling agent, vulcanizing agent and hydroxy silicone oil is provided. The iron oxide in the silicone rubber insulator shed material may react with the silicon dioxide decomposed from silicone rubber to form mullite. This is because iron oxide and aluminum oxide are both sesquioxides, and can replace each other in the mullite lattice. The open space structure of the mullite allowed Fe³⁺ to be accommodated in the empty lattice position to form a solid solution. Original Al₂O₃—SiO₂ binary system was transformed into Al₂O₃—SiO₂—FeO ternary system through adding Fe₂O₃, in which iron ions first reacted with SiO₂ to form iron pyroxene (2FeO·SiO₂), then entered the liquid phase, and then reacted with Al₂O₃ to form iron-containing mullite. The iron-containing mullite effectively isolated heat and oxygen, slowed down the thermal oxygen decomposition of the silicone rubber insulator, and effectively slowed down the hydrophobicity, hydrophobic migration and hydrophobic recovery of the silicone rubber insulator. Moreover, the formation temperature of 2FeO·SiO₂ is lower than 1000° C., which is much lower than the formation temperature of conventional aluminum-containing mullite exceeding 1300° C. Therefore, the iron oxide in the silicone rubber insulator shed material according to the present disclosure can promote the eutectic reaction on the surface of the silicone rubber material, reduce the transformation temperature of mullite crystals, promote and slow down the formation of mullite crystals, and slow down the thermal oxygen decomposition of silicone rubber. Meanwhile, wet flashover of the silicone rubber insulator rarely occurred, and the silicate component of the nano-montmorillonite can form a ceramic layer on the surface of silicone rubber under the local high temperature caused by the dry strip arc, which can effectively isolate heat and oxygen and slow down the thermal oxygen decomposition of silicone rubber.

The nano-montmorillonite component in the silicone rubber insulator shed material was preferably organic hydrophobic modified nano-montmorillonite. This is because the hydrophobic modified nano-montmorillonite may make the silicone rubber composite insulator have lower surface energy and thus better hydrophobicity, improve the hydrophobicity and hydrophobic migration characteristics of the silicone rubber material, and improve the anti-pollution flashover performance of the silicone rubber composite insulator. Similarly, the iron oxide was preferably hydrophobic modified iron oxide.

The silicone rubber insulator shed material comprised preferably 100 parts by weight of silicone rubber, 4 to 8 parts by weight of iron oxide, 3 to 7 parts by weight of nano-montmorillonite, 25 to 40 parts by weight of white carbon black, 70 to 90 parts by weight of aluminum hydroxide, 2 to 4 parts by weight of silane coupling agent, 1 to 3 parts by weight of vulcanizing agent, and 3 to 5 parts by weight of hydroxy silicone oil. The silicone rubber insulator shed material according to the present disclosure inhibited the thermal oxygen decomposition of silicone rubber and contained a relatively high mass fraction of silicone rubber, and is a silicone rubber insulator shed material with a high rubber content.

### Example 2

According to Example 2 of the present disclosure, a method for preparing the silicone rubber insulator shed material according to Example 1 is provided. The method comprised a pretreatment step, a kneading step, a crosslinking reaction step, and a vulcanizing reaction step.

The pretreatment step: 25 parts by weight of fumed nano-white carbon black and 90 parts by weight of aluminum hydroxide were placed in a vacuum drying oven and baked at a high temperature of more than 100° C. for 3 to 4 hours to obtain dried fumed white carbon black and aluminum hydroxide.

The kneading step: the dried fumed white carbon black and aluminum hydroxide were added to the silicone rubber in batches for mixing. The kneading step was performed in a kneader. After the kneading was completed, the mixture was mixed for 0.5 to 1 hour to obtain the silicone rubber insulator material to be crosslinked.

The crosslinking step: 4 parts by weight of iron oxide, 3 parts by weight of organic hydrophobic modified nano-montmorillonite, 2 parts by weight of silane coupling agent, and 3 parts by weight of hydroxy silicone oil were added to the silicone rubber insulator material to be crosslinked. Vacuuming was performed in the kneader for vacuum meshing, wherein the vacuum degree was 0.05 to 0.25 MPa, the temperature was 130 to 160° C., and the crosslinking was performed for 2 to 3 h, to obtain the silicone rubber insulator material to be vulcanized.

The vulcanizing step: the silicone rubber insulator material to be vulcanized was rolled on an open mill; added with 2 parts by weight of 2,5-dimethyl-2,5-bis(tert-butylperoxy) hexane, and subjected to mill run to produce sheets; and then the sheets were placed on a flat vulcanizer for vulcanization molding at 165 to 185° C. and 10 to 12 MPa pressure for 10 to 14 min to obtain the silicone rubber insulator material.

### Example 3

According to Example 3 of the present disclosure, a method for preparing a silicone rubber insulator material is provided. The method of Example 3 differs from that of Example 1 in that the silicone rubber insulator material comprised 5 parts by weight of iron oxide and 4 parts by weight of organic hydrophobic modified nano-montmorillonite.

### Example 4

According to Example 4 of the present disclosure, a method for preparing a silicone rubber insulator material is provided. The method of Example 4 differs from that of Example 1 in that the silicone rubber insulator material comprised 7 parts by weight of iron oxide and 5 parts by weight of organic hydrophobic modified nano-montmorillonite.

### Example 5

According to Example 5 of the present disclosure, a method for preparing a silicone rubber insulator material is provided. The method of Example 5 differs from that of Example 1 in that the silicone rubber insulator material comprised 8 parts by weight of iron oxide and 7 parts by weight of organic hydrophobic modified nano-montmorillonite.

### Example 6

According to Example 6 of the present disclosure, a method for preparing a silicone rubber insulator shed is provided through using the silicone rubber insulator material according to Examples 2-5. The method comprised steps of placing the silicone rubber insulator material and the core rod coated with a binder and pre-baked into a vulcanizer mold at 170 to 190° C. and a pressure of 15 MPa, and high-temperature molding for 15 to 20 min to obtain the required silicone rubber insulator shed.

It should be noted that the silicone rubber insulator shed prepared in Example 6 has excellent performance and can be applied as ultra-high voltage, ultra-high voltage and high voltage silicone rubber insulators.

### Comparative Example 1

According to Comparative Example 1 of the present disclosure, a method for preparing a silicone rubber insulator material is provided. The method of Comparative Example 1 differs from that of Example 2 in that nano-montmorillonite and iron oxide are not added.

### Comparative Example 2

According to Comparative Example 2 of the present disclosure, a method for preparing a silicone rubber insulator shed using the silicone rubber insulator material according to Comparative Example 1 is provided. The method is the same as that of Example 6.

### Test Example 1

This test example is configured to test the performance of the silicone rubber insulator shed prepared in Examples and Comparative Examples 2. The performance test comprises a tracking resistance test, a Raman spectroscopy test, and an X-ray diffraction test.

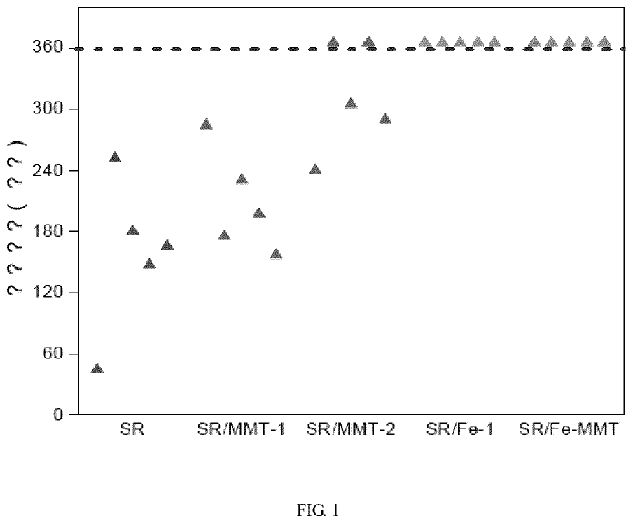

The tracking resistance test machine was used to evaluate the leakage resistance of the surface of solid insulating materials under the combined action of electric field and humid or polluted medium, comprising steps of applying a certain voltage on the surface of a solid insulating material between platinum electrodes of a specified size (2 mm×5 mm) and dripping a specified droplet volume of conductive liquid (0.1% NH₄Cl) at a specified height (35 mm) at a fixed time (30 s). In order to improve the test accuracy, the five silicone rubber insulator shed samples prepared from the silicone rubber insulator shed materials according to Comparative Example 1 and Examples 2-5 were tested respectively. The test was carried out according to IEC60587 through using the DX8427 leakage resistance tracking test device of China Dongguan Daxian Instrument Co., Ltd. The test results were shown in FIG. 1. It can be seen from FIG. 1 that the silicone rubber insulator shed provided in the comparative example without adding additives could not pass the IP test for five times, and the failure time did not exceed 3 hours. Although there are failed samples in the samples according to Examples 2 and 3, the failure time is significantly delayed by increasing the quantity of a sample. The samples according to Examples 4 and 5 can pass the IP test. This shows that in the present application through configuring iron oxide and organic modified montmorillonite as components of silicone rubber insulator sheds, the thermal oxygen decomposition of silicone rubber insulators can be slowed down, the hydrophobicity, hydrophobic migration and hydrophobic recovery of silicone rubber insulators can be effectively slowed down, and the electrical corrosion resistance of silicone rubber materials can be effectively improved.

Furthermore, the silicone rubber insulator shed samples prepared from the silicone rubber insulator shed materials according to Example 5 and Comparative Example 1 were subjected to Raman spectroscopy and X-ray diffraction tests to verify the mechanisms that iron oxide and organic modified montmorillonite can slow down the thermal oxygen decomposition of silicone rubber insulators, effectively slow down the hydrophobicity, hydrophobic migration and hydrophobic recovery of silicone rubber insulators, and effectively improve the electrical corrosion resistance of silicone rubber materials.

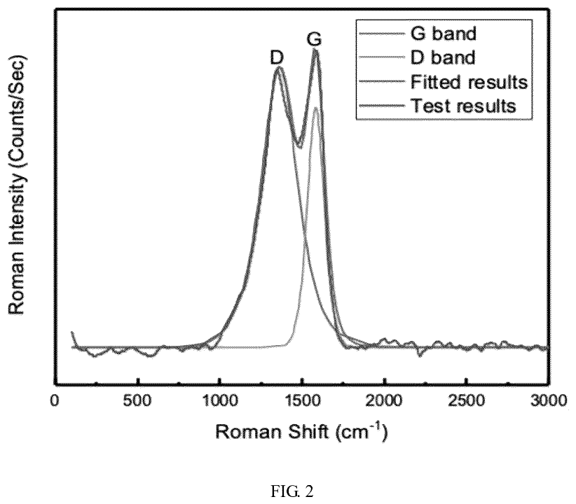

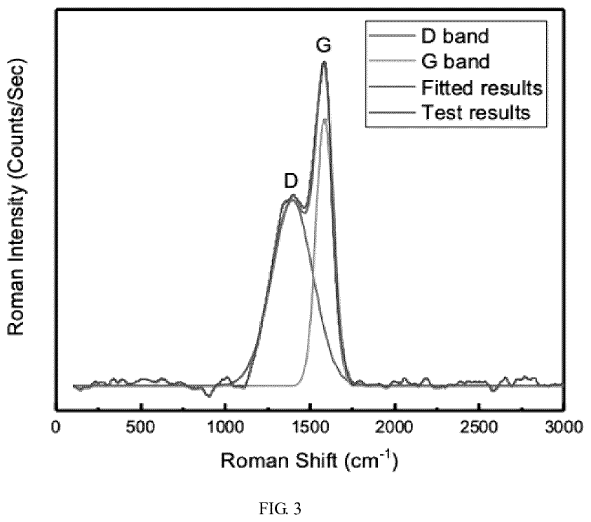

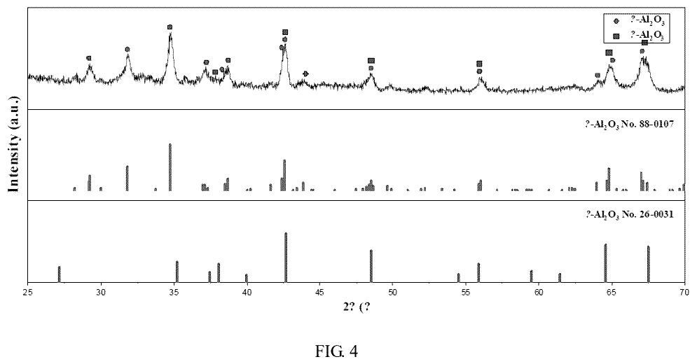

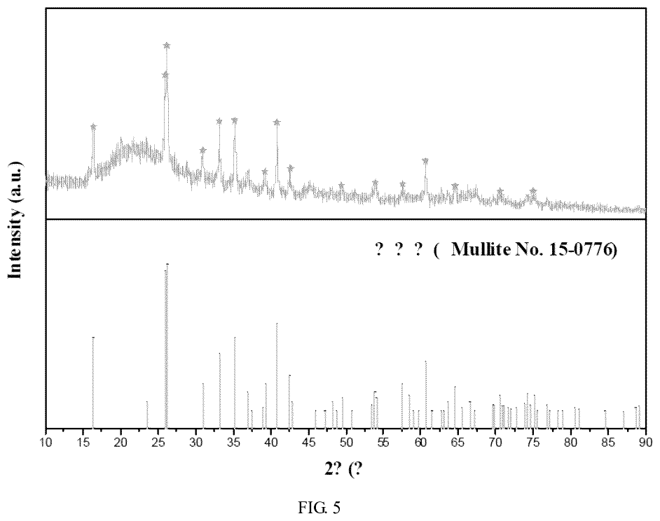

The Raman spectroscopy test results are shown in FIGS. 2-3. It can be seen from FIGS. 2-3 that compared with the silicone rubber insulator shed shown in FIG. 2, the silicone rubber insulator shed added with iron oxide and organic modified montmorillonite shown in FIG. 3 inhibits the formation of graphitized conductive carbon (G band). The X-ray diffraction test results are shown in FIGS. 4-5. It can be seen from FIGS. 4-5 that compared with the silicone rubber insulator shed shown in FIG. 4, the silicone rubber insulator shed added with iron oxide and organic modified montmorillonite shown in FIG. 5 promotes the formation of mullite crystal ceramic layer.

The above examples are only configured to illustrate the technical solutions of the present disclosure, rather than to limit them. Although the present disclosure has been described in detail with reference to the aforementioned examples, those skilled in the art should understand that the technical solutions described in the aforementioned examples can still be modified, or some or all of the technical features therein can be replaced by equivalents. However, the essence of the corresponding technical solutions cannot be deviated from the scope of the technical solutions of the examples of the present disclosure through these modifications or replacements.

1. A silicone rubber insulator shed material, wherein the silicone rubber insulator shed material comprises components of silicone rubber, iron oxide, nano-montmorillonite, white carbon black, aluminum hydroxide, silane coupling agent, vulcanizing agent and hydroxy silicone oil.

2. The silicone rubber insulator shed material according to claim 1, wherein the silicone rubber insulator shed material comprises 100 parts by weight of the silicone rubber, 4 to 8 parts by weight of the iron oxide, 3 to 7 parts by weight of the nano-montmorillonite, 25 to 40 parts by weight of the white carbon black, 70 to 90 parts by weight of the aluminum hydroxide, 2 to 4 parts by weight of the silane coupling agent, 1 to 3 parts by weight of the vulcanizing agent, and 3 to 5 parts by weight of the hydroxy silicone oil.

3. The silicone rubber insulator shed material according to claim 1, wherein the nano-montmorillonite includes organic hydrophobic modified nano-montmorillonite.

4. The silicone rubber insulator shed material according to claim 1, wherein the silicone rubber includes methyl vinyl silicone rubber.

5. The silicone rubber insulator shed material according to claim 1, wherein the white carbon black includes fumed white carbon black;
the vulcanizing agent includes 2,5-dimethyl-2,5-bis(tert-butylperoxy) hexane.

6. A method for preparing the silicone rubber insulator shed material according to claim 1, wherein the method comprises:
step S1, mixing dried fumed white carbon black, aluminum hydroxide and silicone rubber to obtain a silicone rubber insulator material to be cross-linked;
step S2, cross-linking the silicone rubber insulator material to be cross-linked, iron oxide, organic hydrophobic modified nano-montmorillonite, silane coupling agent and hydroxy silicone oil to obtain a silicone rubber insulator material to be vulcanized;
step S3, vulcanizing the silicone rubber insulator shed material to be vulcanized with a vulcanizing agent to obtain a silicone rubber insulator shed material.

7. The method for preparing the silicone rubber insulator shed material according to claim 6, wherein in step S2, the cross-linking is performed at a reaction temperature of 130 to 160° C. for a reaction time of 2 to 3 h;
in step S3, the vulcanizing is performed at a reaction temperature of 165 to 185° C. and a pressure of 10 to 12 MPa for a reaction time of 10 to 14 min.

8. A method for preparing a silicone rubber insulator shed, wherein the method comprises:
step S4, placing the silicone rubber insulator shed material according to claim 1 and an insulator core rod into a vulcanizer mold for molding to form a silicone rubber insulator shed.

9. A silicone rubber insulator shed, which is prepared by the method according to claim 8.

10. A method for preparing ultra-high voltage, extra-high voltage, and high voltage insulators, comprising using the silicone rubber insulator shed according to claim 9.

11. A method for preparing a silicone rubber insulator shed, wherein the method comprises:
step S4, placing the silicone rubber insulator shed material prepared by the method for preparing the silicone rubber insulator shed material according to claim 6 and an insulator core rod into a vulcanizer mold for molding to form a silicone rubber insulator shed.

12. A method for preparing ultra-high voltage, extra-high voltage, and high voltage insulators, comprising using the silicone rubber insulator shed prepared by the method according to claim 8.
